(19) United States
(12) Patent Application Publication
(10) Pub. No.: US 2008/0298449 A1
(43) Pub. Date: Dec. 4, 2008

(54) Method and an apparatus for measuring error vector magnitude, and a measuring apparatus or signal source evaluated or assessed by this method

(76) Inventors: Mitsuru Yokoyama, Hyogo (JP); Kenji Miki, Hyogo (JP)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/807,952

(22) Filed: May 30, 2007

(51) Int. Cl. H04L 1/20

(52) U.S. Cl. 375/227

(57) ABSTRACT

At least one property of a measuring apparatus that is different property from the error vector magnitude is measured, or a previously measured value or a predetermined value of the at least one property is prepared; based on the measured value or specification value of each of the at least one property, each corresponding noise power within a specific frequency range is found; and the error vector magnitude is calculated based on the noise power.

### BACKGROUND

1. Field of the Disclosure

The present disclosure relates to technology for measuring error vector magnitude. The present disclosure is applicable for the measurement of EVM attributed to a measuring apparatus or a signal source.

2. Discussion of the Background Art

Error vector magnitude (EVM) is a parameter for evaluating a digital communications system (for instance, JP Unexamined Patent Publication (Kokai) 2001-285,214 (pages 4 and 5, FIG. 7), JP Unexamined Patent Publication (Kokai) 2003-209,584 (page 3), JP Unexamined Patent Publication (Kokai) 2004-350,218 (page 5, FIG. 2), JP Unexamined Patent Publication (Kokai 2004-096,263 (pages 5 through 8, FIG. 4, FIG. 1), and “Analysis and Trouble Shooting of Vector Modulation Signals Using Error Vector Modulation (EVM),” 2000, Agilent Technologies, Product Note 89400-14). EVM is used as a measure of modulation quality of digital modulation signals. EVM is measured using a measuring apparatus such as a spectrum analyzer or a vector signal analyzer. An apparatus having a function for measuring EVM is referred to hereafter as an apparatus for measuring EVM. The EVM measured by an apparatus for measuring EVM includes not only EVM attributed to the digital modulation signals under test, but also EVM attributed to the apparatus for measuring EVM and the signal line. The EVM attributed to elements other than the signals under test is also called residual EVM. Residual EVM is one item that is used to represent the properties and specifications of an apparatus for measuring EVM. For instance, if ideal digital modulation signals are measured with apparatus in which residual EVM is not zero (0), a value that is not zero (0) will be obtained instead of zero (0),.

The EVM attributed to an apparatus for measuring EVM is classified into two types based on the source. One is EVM attributed to the software of the apparatus for measuring EVM, in essence, the algorithm for measuring EVM. The other is EVM attributed to the hardware of the apparatus for measuring EVM. The EVM attributed to the apparatus for measuring EVM is also called the EVM floor.

There is a need to ascertain the residual EVM of an apparatus for measuring EVM, in essence, the EVM attributed to the apparatus for measuring EVM, as means for representing the properties or specifications of the apparatus for measuring EVM. However, an EVM measuring technology traceable to National standards such as NIST hasn't been established yet. For instance, by means of the current technology for measuring the residual EVM of an apparatus for measuring EVM, digital modulation signals are output by a signal source; the EVM of these output signals is measured by an apparatus for measuring EVM; and the EVM attributed to the signal source or the signal line between the signal source and the apparatus for measuring EVM is subtracted from the EVM measurement results to find the residual EVM of the apparatus for measuring EVM. When this signal line is, for instance, a simple cable, it is possible to conclude that there is no EVM attributed to the signal line between the signal source and the apparatus for measuring EVM. At the present point in time, however, EVM attributed to a signal source, in essence, the residual EVM of the signal source cannot be eliminated perfectly, although it may be reduced through design improvements and the like. Furthermore, at the present time there are no standards for measuring residual EVM of a signal source; therefore, it is impossible to perfectly separate the measured residual EVM into EVM attributed to the signal source and EVM attributed to the measuring apparatus. The EVM attributed to the signal source can be estimated but there will be estimation errors. Consequently, manufacturers of measuring apparatuses always estimate the EVM attributed to the apparatus for measuring EVM that is worse than the actual EVM by the estimation error increment in the EVM attributed to the signal source. This puts the manufacturers of the measuring apparatuses at a disadvantage.

Therefore, there is a need for technology for measuring EVM attributed to the apparatus for measuring EVM, especially, the EVM attributed to the hardware of the apparatus for measuring EVM, by a method traceable to National standards.

The present disclosure solves the above-mentioned problems by calculating the EVM from property values of the measuring apparatus or the signal source that are different property from the EVM. The property value is also called fundamental characteristics. It should be noted that the property values of the measuring apparatus are preferably pure property values of the measuring apparatus. Moreover, the property values of the signal source are preferably pure property values of the signal source. The phrase “pure property values of the measuring apparatus” used here means property values caused only by the measuring apparatus. The phrase “pure property values of the signal source” used here means property values caused only by the signal source.

### SUMMARY OF THE DISCLOSURE

The first subject of the disclosure is a method for measuring error vector magnitude attributed to a measuring apparatus or a signal source comprising a step for measuring at least one property of the measuring apparatus or the signal source that is different property from the error vector magnitude, or for preparing a previously measured value of the at least one property or a predetermined value of the at least one property; a step for finding, based on the measured value or predetermined value of each of the at least one property, each corresponding noise power within a specific frequency range; and a step for finding the error vector magnitude based on the noise power. The phrase “predetermined value” used here means a value that was obtained or defined by means other than measurement, such as specification values or design values.

The second subject of the disclosure is the method for measuring error vector magnitude according to the first subject of the disclosure, further characterized in that the property includes at least one of the following: IF flatness error, phase noise, displayed average noise level, and noise floor.

The third subject of the disclosure is the method for measuring error vector magnitude according to the second subject of the disclosure, further characterized in that the phase noise is phase noise weighted by an offset frequency or an offset frequency range.

The fourth subject of the disclosure is the method for measuring error vector magnitude according to the first subject of the disclosure, further characterized in that the measured value or predetermined value of the property of the measuring apparatus is a value caused only by the measuring apparatus, and the measured value or predetermined value of the property of the signal source is a value caused only by the signal source.

The fifth subject of the disclosure is an apparatus for measuring error vector magnitude attributed to a measuring apparatus or signal source comprising a unit for finding, based on the previously measured value or predetermined value of at least one property of the measuring apparatus or signal source that is different property from the error vector magnitude, each corresponding noise power within a specific frequency range, and a unit for finding the error vector magnitude based on the noise power.

The sixth subject of the disclosure is the apparatus for measuring error vector magnitude according to the fifth subject of the disclosure, further characterized in that the property includes at least one of the following: IF flatness error, phase noise, displayed average noise level, and noise floor.

The seventh subject of the disclosure is the apparatus for measuring error vector magnitude according to the sixth subject of the disclosure, further characterized in that the phase noise is phase noise weighted by an offset frequency or an offset frequency range.

The eighth subject of the disclosure is the apparatus for measuring error vector magnitude according to the fifth subject of the disclosure, further characterized in that the measured value or predetermined value of the property of the measuring apparatus is a value caused only by the measuring apparatus, and the measured value or predetermined value of the property of the signal source is a value caused only by the signal source.

The ninth subject of the disclosure is a measuring apparatus evaluated or assessed based on the measured values of error vector magnitude obtained using a method for measuring error vector magnitude, characterized in that the method for measuring error vector magnitude comprises a step for measuring at least one property of the measuring apparatus or the signal source that is different property from the error vector magnitude, or for preparing a previously measured value of the at least one property or a predetermined value of the at least one property; a step for finding, based on the measured value or predetermined value of each of the at least one property, each corresponding noise power within a specific frequency range; and a step for finding the error vector magnitude based on the noise power.

The tenth subject of the disclosure is the measuring apparatus according to the ninth subject of the disclosure, further characterized in that the property includes at least one of the following: IF flatness error, phase noise, displayed average noise level, and noise floor.

The eleventh subject of the disclosure is the measuring apparatus according to the tenth subject of the disclosure, further characterized in that the phase noise is phase noise weighted by an offset frequency or an offset frequency range.

The twelfth subject of the disclosure is the measuring apparatus according to the ninth subject of the disclosure, further characterized in that the measured value or predetermined value of the property of the measuring apparatus is a value only cause by the measuring apparatus, and the measured value or predetermined value of the property of the signal source is a value caused only by the signal source.

The thirteenth subject of the disclosure is a signal source evaluated or assessed based on the measured values of error vector magnitude, obtained using a method for measuring error vector magnitude, characterized in that the method for measuring error vector magnitude comprises a step for measuring at least one property of the measuring apparatus or the signal source that is different property from the error vector magnitude, or for preparing a previously measured value of the at least one property or a predetermined value of the at least one property; a step for finding, based on the measured value or predetermined value of each of the at least one property, each corresponding noise power within a specific frequency range; and a step for finding the error vector magnitude based on the noise power.

The fourteenth subject of the disclosure is the signal source according to the thirteenth subject of the disclosure, further characterized in that the property includes at least one of the following: IF flatness error, phase noise, displayed average noise level, and noise floor.

The fifteenth subject of the disclosure is the signal source according to the fourteenth subject of the disclosure, further characterized in that the phase noise is phase noise weighted by an offset frequency or an offset frequency range.

The sixteenth subject of the disclosure is the signal source according to the thirteenth subject of the disclosure, further characterized in that the measured value or predetermined value of the property of the measuring apparatus is a value caused only by the measuring apparatus, and the measured value or predetermined value of the property of the signal source is a value caused only by the signal source.

By means of the present disclosure, the EVM is calculated from only pure property values of the measuring apparatus; therefore, the calculated EVM does not include EVM attributed to an apparatus other than the measuring apparatus in question. Similarly, by means of the present disclosure, the EVM is calculated from only pure property values of the signal source; therefore the calculated EVM does not include EVM attributed to a signal source other than the signal source in question.

The property values of the measuring apparatus and the signal source are obtained by a method traceable to National Standards; therefore traceability can be established even for the EVM calculated from these property values.

By means of the present disclosure, EVM is calculated from the property values of only a measuring apparatus or a signal source; therefore, it is not necessary to use additional equipment to measure the EVM.

By means of the present disclosure, the EVM is calculated from only the property values of the measuring apparatus or signal source; therefore, the same procedure can be used to measure the property value in question and the EVM and the related time and cost can be reduced.

By means of the present disclosure, it is possible to calculate EVM without using or loading EVM measurement software in the measuring apparatus; therefore, it is possible to find the EVM attributed to only the hardware of the measuring apparatus.

### BRIEF DESCRIPTION OF THE DRAWINGS

FIG. 1 is a drawing showing evaluation apparatus 10 of an embodiment of the present disclosure.

FIG. 2 is a drawing showing the EVM measurement procedure in evaluation apparatus 10.

FIG. 3 is a drawing showing the concept of an error vector.

FIG. 4 is a drawing showing the EVM measurement procedure of evaluation apparatus 10.

### DETAILED DESCRIPTION OF THE PREFERRED EMBODIMENT

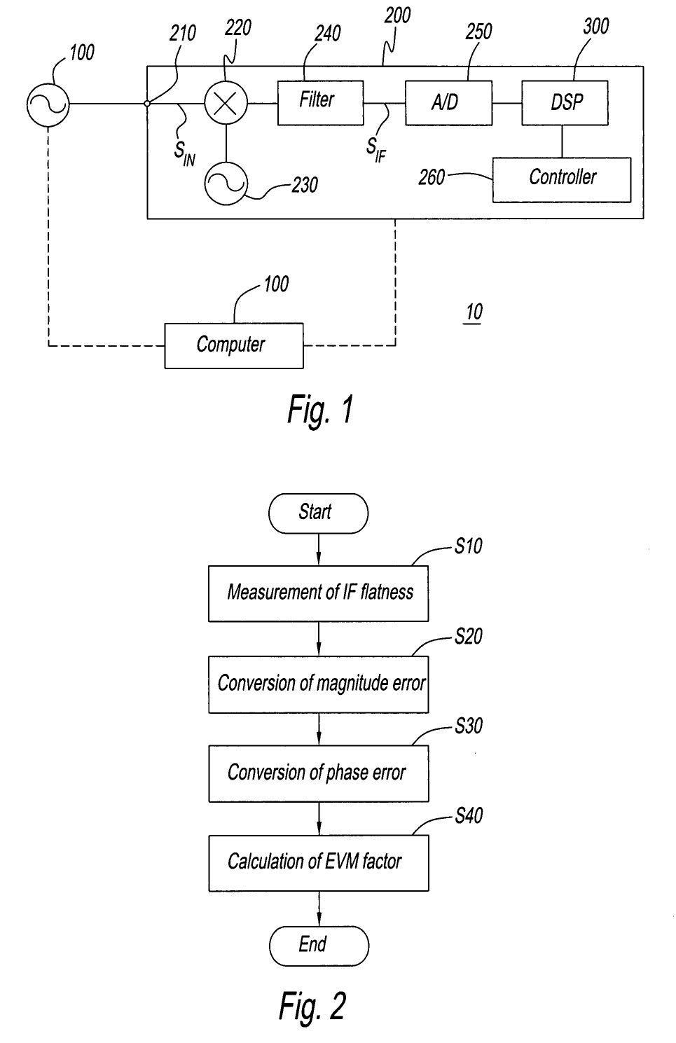

Embodiments of the present disclosure will now be described while referring as needed to the attached drawings. Refer to FIG. 1. FIG. 1 is a drawing showing the structure of an evaluation apparatus 10, which is an embodiment of the present disclosure. Evaluation apparatus 10 is an apparatus for evaluating and assessing a measuring apparatus 200 for analyzing digital modulation signals. First, the structure of evaluation apparatus 10 will be described, and then the procedure for evaluation and assessment of measuring apparatus 200 by evaluation apparatus 10 will be described.

The evaluation apparatus 10 comprises a signal source 100 and a computer 400. Signal source 100 is a modulation signal generator, such as “Agilent (registered trademark) E4438C.”

Measuring apparatus 200, which is the object under test, comprises an input port 210, a mixer 220, a local signal source 230, a filter 240, an analog-to-digital converter (A/D) 250, a digital signal processor (DSP) 300, and a controller 260.

Mixer 220 is a unit for mixing the signals SIN received at data input port 210 with the output signals of local signal source 230, and outputting the mixing results. Filter 240 is a bandpass filter (BPF) or low pass filter (LPF). Signals S_{IN} are converted to signals of a lower frequency, in essence, are down-converted, through the combined action of mixer 220, local signal source 230, and filter 240. Intermediate frequency signals S_{IF}, which are the results of down conversion, are output from filter 240. A/D 250 is a unit for digitalizing signals S_{IF} and outputting the results of digitalization. DSP 300 is a unit for processing digitalized signals S_{IF}. DSP 300 performs a variety of arithmetic processes in accordance with a program stored in a memory that is not illustrated. For instance, by executing a program, DSP 300 subjects digitalized signals S_{IF} to spectrum analysis or digital modulation, or finds the measured values of various parameters for digitalized signals S_{IF}. DSP 300 can be replaced by a processor having arithmetic functions, such as a CPU, FPGA, or computer. Controller 260 is a unit for controlling the structural elements inside measuring apparatus 200 (such as signal source 230, A/D 250, DSP 300, and the like) in accordance with commands of the program stored in a memory or another storage medium that is not illustrated, instructions from a user interface that is not illustrated, or commands from an outside apparatus.

Computer 400 is connected to measuring apparatus 200 and signal source 100 by a wired communications means or wireless communications means. Computer 400 controls these units to which it is connected, and communicates with these units and processes information obtained by communication. Computer 400 operates by execution of programs stored in a memory or another storage medium that is not illustrated.

The procedure by which evaluation apparatus 10 evaluates and assesses measuring apparatus 200 will now be described. Evaluation apparatus 10 measures the residual EVM of measuring apparatus 200 and based on these measurement results, evaluates and assesses measuring apparatus 200. Refer to FIG. 1 and FIG. 2. FIG. 2 is a flow chart showing the procedure for measuring the residual EVM in question. Each of the processes represented in the flow chart is performed as a result of one of the processing units of DSP 300, controller 260, and computer 400 executing a specific program.

First, in step S10, the IF flatness error of measuring apparatus 200 is measured. IF flatness error is a general term for linearity error of magnitude and linearity error of phase in the intermediate frequency stage (IF stage). The method cited in the Specification of U.S. Pat. No. 6,842,608 is an example of a method for measuring IF flatness error. The Specification in U.S. Pat. No. 6,842,608 discloses technology for measuring IF flatness error that does not include characteristics attributed to elements other than the measuring apparatus, such as the signal source or signal line, in essence, the pure IF flatness error, of the measuring apparatus as receiver response Gₖ. In the present step as well, the IF flatness error of measuring apparatus 200 is measured using the method cited in the specification in question. In this case, computer 400 controls the system such that signal source 100 produces signals having a bandwidth that is not zero, and DSP 300 executes a program for analyzing the spectrum of at least the signals S_{IF}.

As a result of executing this step S10, error data such as shown, for instance, in Table 1 are obtained as measured values of the IF flatness error. Table 1 gives the phase error (degrees) and the magnitude error (dB) at each frequency (Hz) in intervals of 100 kHz within a frequency range of the central frequency±3.1 MHz. The phase error is the relative phase error using as the criterion the phase measured when the measurement was started. Moreover, the magnitude error is the value relative to the magnitude value at central frequency (0 Hz in Table 1). Central frequency is the central frequency of the frequency band that is the object under test in the IF stage. This central frequency, for instance, corresponds to the center of the resolution bandwidth in the case of spectrum analysis by DSP 300, and corresponds to the carrier wave frequency of signals under test in the case of digital demodulation by DSP 300.

TABLE 1
IF flatness error data

| Frequency (Hz) | Phase error (degrees) | Magnitude error (dB) |
|---|---|---|
| −3100000 | 0.52000 | −0.18705 |
| −3000000 | 0.65000 | −0.21937 |
| −2900000 | 0.91000 | −0.20023 |
| −300000 | 0.14000 | −0.02859 |
| −200000 | 0.35000 | −0.01274 |
| −100000 | 0.49000 | −0.00292 |
| 0 | 0.49000 | 0.00000 |
| 100000 | 0.49000 | 0.00292 |
| 200000 | 0.46000 | 0.01279 |
| 300000 | 0.45000 | 0.00679 |
| 2900000 | 0.55000 | 0.18570 |
| 3000000 | 0.64000 | 0.18458 |
| 3100000 | 0.57000 | 0.20188 |

In step S20, the magnitude error obtained in step S10 is subjected to conversion processing. Specifically, the average value of the magnitude error within a specific frequency range is found and the normalized magnitude error is obtained by using this average to normalize each of the magnitude errors. The specific frequency range is determined from the bandwidth of the signals (signals under test) that are the subject of actual EVM measurements. For instance, the specific frequency range is determined by the bandpass width of the receiver filter and is 3.84 MHz in the case of W-CDMA. In essence, it is central frequency±1.9 MHz in Table 1. The magnitude error that has been subjected to conversion processing in step S20 is called the converted magnitude error.

In the case of processing based on the error data shown in Table 1, the normalized magnitude error is found by the procedures in (A-1) through (A-3) for error data within a predetermined frequency range.

(A-1) Each magnitude error expressed in decibel (dB) units is individually converted to a linear value. For instance, if X is the magnitude error expressed in decibel (dB) units, this linear value is 10^{X/20}.

(A-2) The average value of the magnitude errors expressed as linear values is found.

(A-3) Each of the magnitude errors expressed as a linear value is individually divided by the calculated average.

It should be noted that (A-3) can be replaced by (A-4) through (A-6).

(A-4) The calculated average is converted to decibel units.

(A-5) Each average in decibel units is individually subtracted from the magnitude difference in decibel units.

(A-6) Each subtraction result is individually converted to a linear value.

In step S30, the phase error obtained in step S10 is subjected to conversion processing. Specifically, the first-order approximation function of the phase error within a predetermined frequency range is found and the corresponding approximate value is subtracted from the respective phase error. The phase error that has been subjected to the conversion processing in step S30 is hereafter referred to as the converted phase error.

In the case of processing based on the error data shown in Table 1, the normalized phase error is found by the procedures in (B-1) and (B-2) for error data within a predetermined frequency range.

(B-1) The first-order approximation function for the phase error is found.

(B-2) The approximate value corresponding to each phase error is found based on the resulting first-order approximation function. Each approximate value is individually subtracted from corresponding phase error.

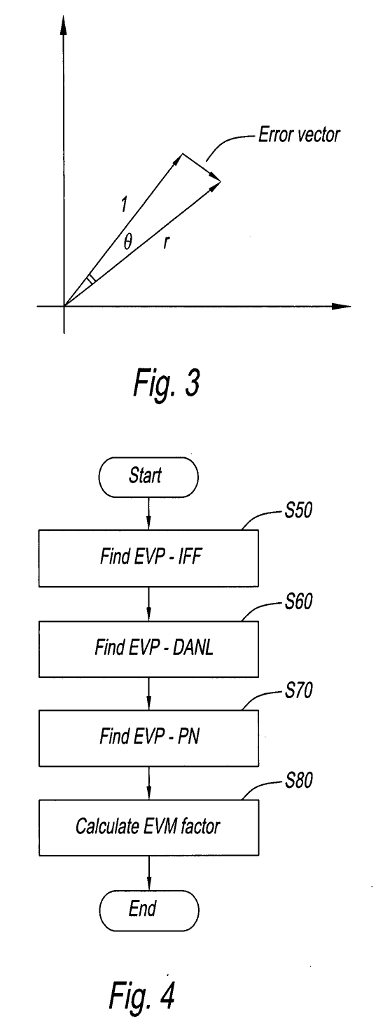

Finally in step S40, the EVM is found based on the average noise power converted from IF flatness error. The specifics are as follow. First, this step finds the size of each error vector as expressed by each converted magnitude error and each converted phase error within a predetermined frequency range. Then the size of each error vector is squared. The resulting value is the power of each error vector. Furthermore, the average noise power, which is the average of these power values, is found. The EVM is obtained by calculating the square root of the average noise power. The resulting EVM is called the EVM factor so as to be differentiated from the EVM obtained by the prior art. By way of comparison, refer to FIG. 3. FIG. 3 is a drawing showing the error vector as expressed by the converted magnitude error r and the converted phase error 0. The vector represented by 1 in FIG. 3 is the reference vector.

Formula (1) shows the processing expressed as a mathematical formula when the error data shown in Table 1 are subjected to the processing in step S40. HBW is the half width of the predetermined frequency range. N is the number of frequency points within a predetermined frequency range. For instance, in the case of W-CDMA, HBW=1,900,000 (Hz) and N=39. e(f) is the power of the error vector at frequency f. r(f) is the converted magnitude error at frequency f θ(f) is the converted phase error at frequency f.

$$\begin{matrix}\text{Mathematical formula 1} & \\ \begin{matrix}EVMfactor = \sqrt{\frac{{\sum }_{f = - HBW}^{* HBW} {e ( f )}^{2}}{N}} \\ = \sqrt{\frac{{\sum }_{f = - HBW}^{* HBW} \{ 1 + {r ( f )}^{2} - 2 \cdot r ( f ) \cdot cos θ ( f ) \}}{N}}\end{matrix} & ( 1 )\end{matrix}$$

When the error data in Table 1 are tentatively subjected to the processing in steps S10 through S40 under HBW=0.3 MHz and N=7, the EVM factor becomes approximately 0.00211 (approximately 0.211%).

However, there are cases where, as with IF flatness error, the displayed average noise level and phase noise have an effect on the EVM of measuring apparatus 200. When the IF flatness error is taken into consideration together with the displayed average noise level and the phase noise, the EVM is calculated using formula (2) in place of formula (1). In this case, evaluation apparatus 10 measures the residual EVM of measuring apparatus 200 in accordance with the flow chart shown in FIG. 4, and measuring apparatus 200 is evaluated and assessed based on these measurement results. Refer to FIG. 1 and FIG. 4. FIG. 4 is a flow chart showing the procedure for measuring the residual EVM. Each process represented by this flow chart is accomplished as a result of a specific program being executed by any of the processing units of DSP 300, controller 260, and computer 400.

$$\begin{matrix}\text{Mathematical formula 2} & \\ EVMfactor = \sqrt{{EVP}_{IFF} + {EVP}_{SNR} + {EVP}_{PN}} \\ where , {EVP}_{IFF} = \frac{{\sum }_{f = - HBW}^{+ HBW} \{ 1 + {r ( f )}^{2} - 2 \cdot r ( f ) \cdot cos θ ( f ) \}}{N} & ( 2 )\end{matrix}$$

EVP_{IFF} here is the average noise power converted from the IF flatness error and is equal to the squared result in formula (1). EVP_{DANL} is the average noise power converted from the displayed noise power level. EVP_{PN} is the noise power converted from the phase noise. It should be noted that EVP_{IFF}, EVP_{DANL}, and EVP_{PN} are not absolute values and are values normalized by the reference power.

First, in step S50, EVP_{IFF} is found, EVP_{IFF} is obtained as the squared result in formula (1). The r(f) and θ(f) needed to calculated the square in formula (1) are obtained by performing steps S10 through S30 in FIG. 2.

Next, in step S60, EVP_{DANL} is found. EVP_{DANL} is given as a ratio of the average noise power within a specific frequency range as converted from the displayed average noise to the signal power. In other words, EVP_{DANL} is the result of normalizing the average noise power in question by the signal power in question. For instance, EVP_{DANL} at a band of 2 GHz, which is one of the frequency bands used by W-CDMA in Japan, is found as follows. The case of a pre-acquired displayed average noise level (also referred to as average displayed noise level value) is found as follows. The typical displayed average noise level of a signal analyzer (Agilent (registered trademark) N9020A) at a band of 2 GHz is −154 dBm when the preamp is off, according to the N9020A specifications. This typical value is the displayed average noise level in case where the resolution bandwidth is 1 Hz. Therefore, this typical value is converted to the value within a specific frequency range. The bandpass width of the receiver filter of W-CDMA is 3.84 MHz, therefore, 10×LOG (3.84×10⁶)=65.8 dB is added to the above-mentioned typical value. As a result, −154 dBm+65.8 dB=−88.2 dBm is obtained as the average power of the displayed average noise within a specific frequency range. When the level of signals input to measuring apparatus 200 (level of signals under test) in an actual measurement is tentatively −25 dBm, EVP_{DANL} as expressed in decibel units becomes (−88.2 dBm)−(−25 dBm)=−63.2 dB. In this case, the linear value of 10^{-6.32} is used as the EVP_{DANL} in formula (2). When the displayed average noise level is not pre-acquired, EVP_{DANL} is obtained as follows. Measuring apparatus 200 is subjected to spectrum analysis without feeding signals to measuring apparatus 200. The analysis results show the displayed average noise. In general, the displayed average noise level is represented by power; therefore, when the analysis results are averaged within a specific frequency range in this case, the average value of the displayed average noise level is found. Moreover, EVP_{DANL} is obtained by using the signal power to normalize the average value of the displayed average noise power within a specific frequency range. It should be noted that EVP_{DANL} decreases as the input signal level increases, so that it can be disregarded.

Next, in step S70, EVP_{PN} is found. EVP_{PN} is given as the total phase noise. The phase noise is obtained by applying signals with such a small phase noise that it can be disregarded to measuring apparatus 200, and using measuring apparatus 200 to measure the phase noise of the input signals. In this case, DSP 300 executes the program for analyzing the phase noise of at least the signals S_{IF}. The phase noise is given by power at offset frequency expressed in dBc/Hz, and EVP_{PN} is therefore found by integrating the phase noise by the offset frequency. In this case, EVP_{PN} is obtained as the power relative to the carrier power, in other words, power normalized by carrier power. The frequency range for integration is theoretically the entire frequency range, but can also be limited to the frequency range that affects EVP_{PN}.

Moreover, there are cases in which the effect of phase noise on the EVM differs with offset frequency. For instance, the effect of phase noise on the EVM of measuring apparatus 200 for measuring OFDM signals varies with the offset frequency. In this case, when the EVM factor is found using the EVP_{PN} obtained by simple integration of the phase noise by the offset frequency, an error may be produced in the resulting EVM factor. Therefore, in order to eliminate or reduce this error, the EVPis calculated by weighting the phase noise for each offset frequency range and integrating the weighted phase noise in question. As a result, it is possible to precisely find the EVM attributed to measuring apparatus 200, even in cases in which the effect of the phase noise on the EVM differs with offset frequency. For instance, the phase noise at an offset frequency having a strong effect on EVM is weighted relatively heavily (for instance, a weighting coefficient of 1), while the phase noise at an offset frequency having a small effect on the EVM is weighted relatively lightly (for instance, a weighting coefficient of 0.1 or smaller). Moreover, measuring apparatus 200 or computer 400 comprises a user interface for selection or input by an operator and a memory for storing coefficients for weighting as needed. Furthermore, measuring apparatus 200 can measure the square root of the integrated value of the weighted phase noise, in essence, the RMS value of the weighted phase noise, rather than the integrated weighted phase noise.

Finally, in step S80, the EVM factor is found based on each noise power derived from the IF flatness error, displayed average noise level, and phase noise. Specifically, the EVM factor is calculated using above-mentioned formula (2).

It should be noted that although this is not shown in the flow charts in FIG. 2 and FIG. 4, evaluation apparatus 10 outputs the EVM factor obtained by performing the above-mentioned processing as the evaluation result of measuring apparatus 200. Moreover, evaluation apparatus 10 assesses the resulting EVM factor using a specific value as the criterion and outputs the assessment result. Furthermore, evaluation apparatus 10 can also perform evaluation or assessment. The term “output” used here means output that can be used by the operator and is output to a display that is not illustrated, a memory that is not illustrated, a communications unit not illustrated, and the like.

The down conversion in the above-mentioned embodiment is down conversion by single-stage, but the present disclosure can be effectively used on measuring apparatuses that perform down conversion of multiple stages. In this case, the “IF” in the above-mentioned embodiment should be read as “final IF.”

Moreover, in addition to being measured by measuring apparatus 200 during calculation of the EVM factor, the IF flatness error, the displayed average noise level, and the phase noise, which are property values of measuring apparatus 200, can be premeasured and used at the time of EVM factor calculation. In this case, for instance, measuring apparatus 200 or computer 400 stores the premeasured property values in a memory that is not illustrated.

Thus far, the EVM factor has been used to represent the EVM attributed to any EVM measuring apparatus. However, the method for calculating the EVM factor can be used even to find the EVM attributed to a signal source that generates modulation signals. In other words, the method for calculating the EVM factor can be used, even to find EVM that is unintentionally included in the output signals of a signal source, in essence, to find the residual EVM of a signal source. For instance, at least one of the properties of IF flatness error, phase noise, and noise floor is considered as a property value of a signal source. In this case, the EVM factor is found based on the each corresponding average noise power within a specific frequency range as calculated from each property value. The EVM factor is obtained as the square root of the sum of average noise powers as in formula 2. The property value of the signal source is measured by a spectrum analyzer (for instance, Agilent (registered trademark) E 4443A) or a phase noise measuring unit (for instance, Agilent (registered trademark) E 5052A).

For example, the IF flatness error of a signal source is obtained by measuring the spectrum of the output signals of the signal source using a spectrum analyzer. In this case, IF flatness error attributed to the spectrum analyzer is included in the resulting IF flatness of the signal source. However, the IF flatness attributed to the spectrum analyzer is individually obtained as described above. Consequently, the pure IF flatness error of the signal source is obtained by correcting the resulting IF flatness error by the IF flatness error attributed to the spectrum analyzer. Phase noise is obtained by outputting the signals of a single frequency from a signal source and measuring the output signals using a phase noise measuring unit. However, as in the case where modulation signals are produced, for instance, it is necessary to use the same signal path inside the signal source. The noise floor is obtained by measuring the spectrum of the output signals of a signal source using a spectrum analyzer with such a narrow resolution bandwidth that noise attributed to the spectrum analyzer can be ignored. The procedure for finding the average noise power within a specific frequency range from the IF flatness error and the phase noise is the same as in the case of measuring apparatus 200. Moreover, when the noise floor is represented by power, it is possible to find the desired average noise power by averaging the noise floor within a specific frequency range. Furthermore, the IF in the signal source refers to the baseband IF when down-conversion of two or more steps is performed.

Moreover, as long as it is a property of the measuring apparatus or signal source that will affect the EVM, the EVM attributed to the measuring apparatus or signal source is not limited to the above-mentioned IF.

The property value of the measuring apparatus or signal source can be a value obtained by measuring the property in question as described above, or it can be a specification value of the property in question. In this case as well, it is preferred that the property value in question is a pure property value of the measuring apparatus or signal source.

What is claimed is:

1. A method for measuring error vector magnitude attributed to a measuring apparatus or a signal source, said method for measuring error vector magnitude comprising:
measuring at least one property of said measuring apparatus or said signal source that is different property from the error vector magnitude, or for preparing a previously measured value of said at least one property or a predetermined value of said at least one property;
finding, based on the measured value or predetermined value of each of said at least one property, each corresponding noise power within a specific frequency range; and
finding the error vector magnitude based on said noise power.

2. The method for measuring error vector magnitude according to claim 1, wherein said property comprises at least one property selected from the group consisting of: IF flatness error, phase noise, displayed average noise level, and noise floor.

3. The method for measuring error vector magnitude according to claim 2, wherein said phase noise is phase noise weighted by an offset frequency or an offset frequency range.

4. The method for measuring error vector magnitude according to claim 1, wherein the measured value or predetermined value of the property of the measuring apparatus is a value caused only by the measuring apparatus, and the measured value or predetermined value of the property of the signal source is a value caused only by the signal source.

5. An apparatus for measuring error vector magnitude attributed to a measuring apparatus or signal source, said apparatus for measuring error vector magnitude comprising:
a unit for finding, based on the previously measured value or the predetermined value of at least one property of said measuring apparatus or signal source that is different property from the error vector magnitude, each corresponding noise power within a specific frequency range, and
a unit for finding the error vector magnitude based on said noise power.

6. The apparatus for measuring error vector magnitude according to claim 5, wherein said property comprises at least one property selected from the group consisting of: IF flatness error, phase noise, displayed average noise level, and noise floor.

7. The apparatus for measuring error vector magnitude according to claim 6, wherein said phase noise is phase noise weighted by an offset frequency or an offset frequency range.

8. The apparatus for measuring error vector magnitude according to claim 5, wherein said measured value or predetermined value of the property of the measuring apparatus is a value cause only by the measuring apparatus, and the measured value or predetermined value of the property of the signal source is a value caused only by the signal source.

9. A measuring apparatus evaluated or assessed based on the measured values of error vector magnitude obtained using a method for measuring error vector magnitude, said method for measuring error vector magnitude comprises:
measuring at least one property of said measuring apparatus or said signal source that is different property from the error vector magnitude, or for preparing a previously measured value of said at least one property or a predetermined value of said at least one property;
finding, based on the measured value or predetermined value of each of said at least one property, each corresponding noise power within a specific frequency range; and
finding the error vector magnitude based on said noise power.

10. The measuring apparatus according to claim 9, wherein said property comprises at least one property selected from the group consisting of: IF flatness error, phase noise, displayed average noise level, and noise floor.

11. The measuring apparatus according to claim 10, wherein said phase noise is phase noise weighted by an offset frequency or an offset frequency range.

12. The measuring apparatus according to claim 9, wherein said measured value or predetermined value of the property of the measuring apparatus is a value caused only by the measuring apparatus, and the measured value or predetermined value of the property of the signal source is a value caused only by the signal source.

13. A signal source for evaluated or assessed based on the measured values of error vector magnitude obtained using a method for measuring error vector magnitude, said method for measuring error vector magnitude comprising:
measuring at least one property of said measuring apparatus or said signal source that is different property from the error vector magnitude, or for preparing a premeasured value of said at least one property or a predetermined value of said at least one property;
finding, based on the measured value or predetermined value of each of said at least one property, each corresponding noise power within a specific frequency range; and
finding the error vector magnitude based on said noise power.

14. The signal source according to claim 13, wherein said property comprises at least one property selected from the group consisting of: IF flatness error, phase noise, displayed average noise level, and noise floor.

15. The signal source according to claim 14, wherein said phase noise is phase noise weighted by an offset frequency or an offset frequency range.

16. The signal source according to claim 13, wherein said measured value or predetermined value of the property of the measuring apparatus is a value caused only by the measuring apparatus, and the measured value or predetermined value of the property of the signal source is a value caused only by the signal source.
